(19) United States
(12) Patent Application Publication
(10) Pub. No.: US 2012/0255410 A1
(43) Pub. Date: Oct. 11, 2012

(54) CUTTING APPARATUS

(76) Inventors: Hisayoshi Kido, Tokyo (JP); Soyu Yoshihara, Tokyo (JP)

(21) Appl. No.: 13/518,324

(22) PCT Filed: Jan. 26, 2010
(86) PCT No.: PCT/JP2010/050966

§ 371 Date: Jun. 21, 2012

(51) Int. Cl. B23D 15/06

(52) U.S. Cl. 83/202

(57) ABSTRACT

A cutting apparatus that cuts a plate-like body in a feeding direction thereof includes: a first die disposed on one side of the plate-like body with a plurality of cutting blades, which include fixing portions, mounted thereon. A second die disposed on another side of the plate-like body with a plurality of cutting blades, which correspond to the cutting blades mounted on the first die, Fixing portions, mounted thereon by attaching the fixing portions and a driving apparatus for driving at least one of the first die and the second die toward the other die, wherein the lower mold and the upper mold have a plurality of attachment holes which, to enable the fixing portions to be inserted and mounted, are each formed with inner wall surfaces that contact the entire periphery of a fixing portion and an inner bottom surface that contacts a bottom surface of the fixing portion.

### TECHNICAL FIELD

The present invention relates to a cutting apparatus that forms a plate-like body intermittently fed in a specified direction into a plurality of strips in the feeding direction.

### BACKGROUND ART

FIG. 10 depicts heat exchanger fins used in a radiator unit of a heat exchanger. The fins are made from a wide metal strip (or “plate-like body”) that has a plurality of collar rows formed in a width direction thereof, a collar row being a plurality of collar-equipped holes 12, 12, . . . , into which radiator pipes are inserted, formed in a row in the length direction.

This metal strip 10 is cut in the length direction thereof to form a plurality of narrow strips on which one collar row is formed, and then such strips are cut into predetermined lengths to form short fins. Such manufacturing of radiator plates is carried out using the press apparatus 18 depicted in FIG. 11.

In the press apparatus 18, a metal strip 10 made of aluminum or the like that is to be machined to produce the heat exchanger fins is pulled out via pinch rolls 16 from an uncoiler 14 around which the metal strip 10 has been wound. The pulled out metal strip 10 is inserted into an oil-applying apparatus 20 and after machining oil has been applied on the surface, the metal strip 10 is intermittently fed to a die apparatus 22 provided in the press apparatus 18.

The die apparatus 22 is a progressive die and internally includes an upper die set 22a capable of up-down movement and a lower die set 22b that is static. In the metal strip 10 that has passed the die apparatus 22, a plurality of collar rows, where collar-equipped holes 12, 12 are formed in rows in the feeding direction (the length direction of the metal strip 10), are formed in the width direction of the metal strip 10.

After cutting the metal strip 10 in the length direction using a cutting apparatus 24 to form a plurality of narrow strips in which one collar row is formed, the strips are then cut into predetermined lengths to produce short fins that are stored in a stacker 26.

As depicted in FIG. 12, in the cutting apparatus 24, cutting blades 100 that cut the metal strip 10 are disposed on an upper surface and a lower surface side of the metal strip 10 and the metal strip 10 is cut by being sandwiched above and below by edge portions at the front of the cutting blades (see for example Patent Document 1).

The cutting blades 100 are formed so as to be elongated in the length direction of the metal strip 10 and a plurality of such cutting blades 100 are disposed between the rows of the fins to be formed.

The cutting blades 100 are mounted on the fixing portions 102 in the form of rectangular columns that extend in the length direction of the metal strip 10, and a plurality of the fixing portions 102 are mounted both on an upper die 13 that is disposed above the metal strip 10 and is capable of moving and a lower die 19 that is disposed below the metal strip 10 and is fixed so as to not move.

As depicted in FIG. 13, fixing channels 15 into which the fixing portions 102 on which the cutting blades 100 are mounted are inserted and fixed are formed on the upper die 13 and the lower die 19. The fixing channels 15 extend in the length direction of the cutting blades 100 and the fixing portions 102 and both ends 15a in the length direction of the fixing channels 15 are formed by cutting away so as to be exposed to the side surfaces of the upper die and the lower die.

Note that the positioning of the cutting blades 100 when the fixing portions 102 have been inserted into the fixing channels 15 is achieved by placing bumper members 16 in contact on the side surfaces of the upper die 13 and the lower die 19 and moving the fixing portions 102 in the length direction of the channels 15 until the end portions of the fixing portions 102 contact the bumper members 16.

### Patent Document 1

Japanese Laid-Open Patent Publication No. 2007-339891

### DISCLOSURE OF THE INVENTION

In recent years, in response to demand to make heat exchangers smaller and slimmer, it has become necessary to manufacture heat exchanger fins with a narrow pitch. For this reason, in a cutting apparatus 24 for manufacturing narrow heat exchanger fins, the spacing at which the cutting blades 100 are disposed becomes extremely short.

In this case, it is difficult to reliably fix the fixing portions 102 using only frame portions 17 formed between a given fixing channel 15 and the adjacent fixing channel 15, resulting in the problem of the risk of the fixing portions 102 and the cutting blades 100 collapsing due to deformation of the frame portions 17.

After many tooling changes and/or long-term usage, there is also the risk of the fixing channels 15 widening. In such case, the clearance between the cutting blades 100 on the upper die 13 and the upper die 13 increases, creating a further problem of increased likelihood of improper cutting.

The present invention was conceived to solve the problems described above and has an object of providing a cutting apparatus capable of preventing collapsing of the cutting blades and improper cutting, even when the spacing between the plurality of cutting blades has been narrowed.

A cutting apparatus according to the present invention cuts a plate-like body progressively and intermittently fed in a predetermined direction in a feeding direction thereof to form a plurality of narrow strips and includes: a first die that is disposed one of above and below a surface of the plate-like body and has a plurality of cutting blades, which include fixing portions, mounted thereon by attaching the fixing portions; a second die that is disposed another of above and below the surface of the plate-like body and has a plurality of cutting blades, which correspond to the cutting blades mounted on the first die, cut the plate-like body, and include fixing portions, mounted thereon by attaching the fixing portions; and a driving apparatus that drives at least one of the first die and the second die toward and away from another of the first die and the second die, wherein a plurality of attachment holes into which the fixing portions are inserted and mounted are formed in the first die and the second die, and each attachment hole is formed with inner wall surfaces that contact the entire periphery of a fixing portion and an inner bottom surface that contacts a bottom surface of the fixing portion.

By using the above construction, instead of fixing the fixing portions of the cutting blades using only frame portions as in the past, the die is constructed around the entire peripheral surface of the fixing portions, and therefore it is possible to effectively prevent the cutting blades from collapsing. It is also possible to prevent the fixing portions from widening.

Also, the first die and the second die may also include: a first member that has through-holes, in which the inner wall surfaces of the attachment holes are formed, formed in a hardening material that has been hardened by hardening; and a second member that is mounted on an opposite side of the first member to a side into which the fixing members are inserted and covers the through-holes of the first member to construct inner bottom surfaces of the attachment holes.

With the above construction, although it is preferable to machine the hardened hardening material by wire discharge machining, it is not possible with typical wire discharge machining for example to form concave portions formed with bottom surfaces. For this reason, by constructing the bottom surfaces using a separate member, it is possible to form the attachment holes by machining a hard member by wire discharge machining.

In addition, at least one of the first die and the second die may include a moving means that causes the attached single or plurality of cutting blades to advance toward and withdraw from the plurality of cutting blades attached to the other mold to move the single or plurality of cutting blades between a cutting position where the cutting blades are capable of cutting the plate-like body and a non-cutting position where the cutting blades are incapable of cutting the plate-like body.

Since it is sufficient to change the spacing of the cutting blades when changing the width of the fins to be formed, when changing for example from narrow fins to wide fins, it is possible to form the wide fins by removing cutting blades from a die. However, such a tooling change for the cutting blades that changes the width of the fins is required and takes time and effort. However, by making the positions of the cutting blades movable between the non-cutting position and the cutting position, it is possible to easily change the width of the fins.

The moving means may have one or a plurality of concave portions and raising surfaces formed on both sides of the concave portions formed on bottom surfaces of the fixing portions of the cutting blades, may be equipped with a slide member capable of sliding in contact with bottom surfaces of the fixing portions, may have one or a plurality of pressing protrusions that protrude toward the bottom surfaces of the fixing portions formed in a surface of the slide member that contacts the bottom surfaces of the fixing portions, and may be provided to cause the slide member to slide and, when the pressing protrusions have advanced into the concave portions of the bottom surfaces of the fixing portions, moves the cutting blades to the non-cutting position where the cutting blades are incapable of cutting the plate-like body, and when the pressing protrusions have ridden up onto the raising surfaces, moves the cutting blades to the cutting position where the cutting blades are capable of cutting the plate-like body.

With the above construction, since it is possible to move a cutting blade between the cutting position and the non-cutting position by merely sliding a slide member, it is possible to easily change the width of the fins.

The moving means may be equipped with pressing pins that contact bottom surfaces of the fixing portions of the cutting blades and press the bottom surfaces of the fixing portions so as to move the cutting blades between the non-cutting position where the cutting blades are incapable of cutting the plate-like body and the cutting position where the cutting blades are capable of cutting the plate-like body.

With the above construction, since it is possible to move a cutting blade between the cutting position and the non-cutting position by merely operating the pressing pin, it is possible to easily change the width of the fins.

Note that the respective fixing portions may have insertion positions for the attachment holes provided at a plurality of positions, and a plurality of attachment holes may be provided for each fixing portion to enable the plurality of insertion positions of the fixing portion to be inserted.

### Effect of the Invention

According to the present invention, it is possible to prevent cutting blades from collapsing and improper cutting.

### BRIEF DESCRIPTION OF THE DRAWINGS

FIG. 1 is a side view of a first embodiment of a cutting apparatus.

FIG. 2 is a front view of the first embodiment of a cutting apparatus.

FIG. 3 is a plan view of an upper die or a lower die of the first embodiment of a cutting apparatus.

FIG. 4 is a side view of a second embodiment of a cutting apparatus.

FIG. 5 is a plan view of an upper die or a lower die of the second embodiment of a cutting apparatus.

FIG. 6 is a diagram useful in explaining a state where the cutting blades of the upper die according to the second embodiment are positioned at a cutting position.

FIG. 7 is a diagram useful in explaining a state where the cutting blades of the upper die according to the second embodiment are positioned at a non-cutting position.

FIG. 8 is a side view of a third embodiment of a cutting apparatus.

FIG. 9 is a plan view of an upper die or a lower die of a fourth embodiment of a cutting apparatus.

FIG. 10 is a plan view of typical heat exchanger fins.

FIG. 11 is a diagram useful in explaining a manufacturing apparatus that manufactures heat exchanger fins.

FIG. 12 is a front view of an existing cutting apparatus.

FIG. 13 is a plan view of an upper die or a lower die of an existing cutting apparatus.

### BEST MODE FOR CARRYING OUT THE INVENTION

### First Embodiment

Preferred embodiments of a cutting apparatus according to the present invention will now be described.

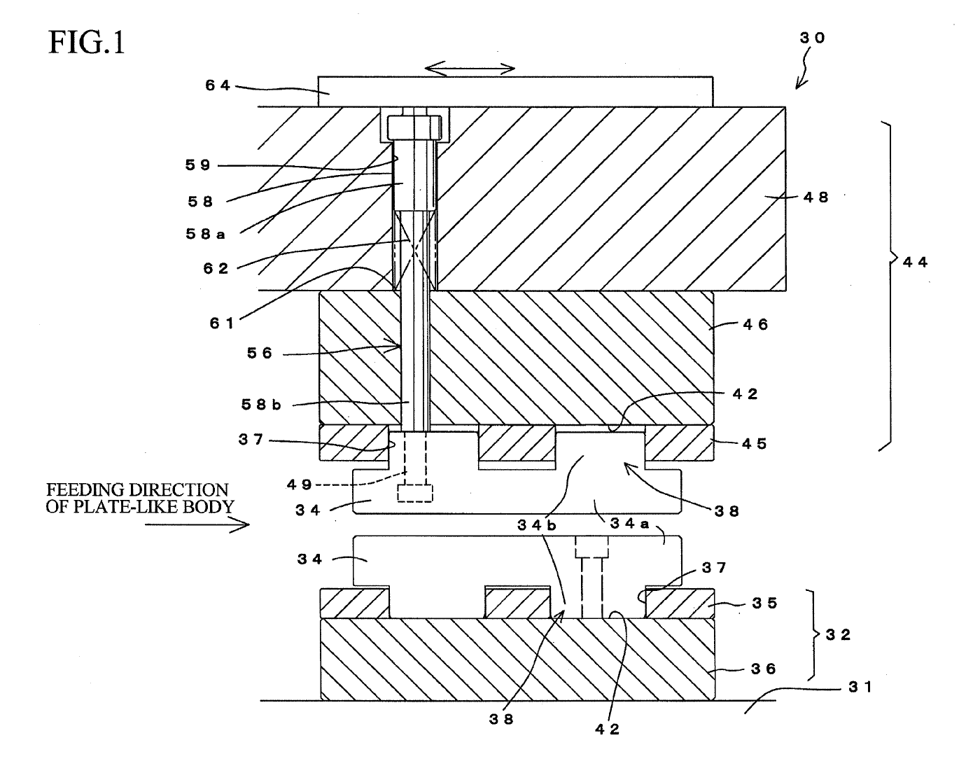

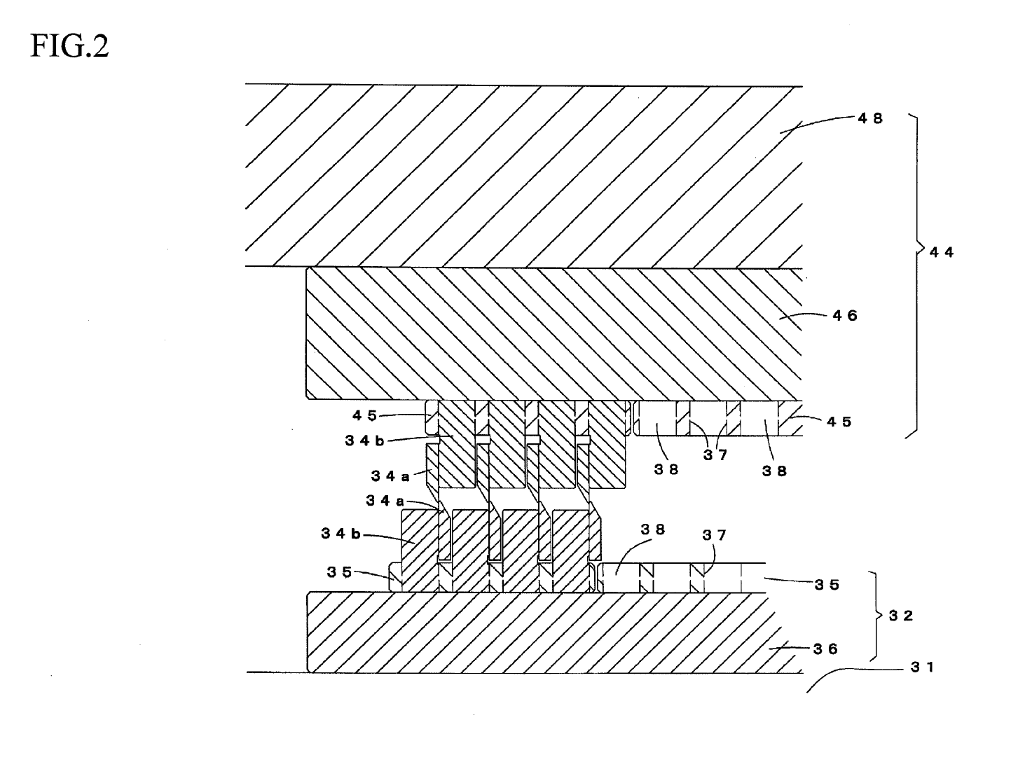

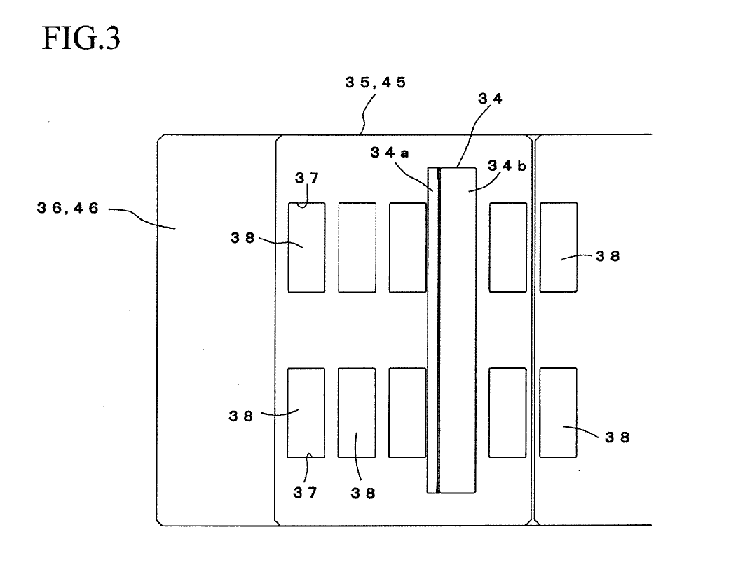

FIG. 1 depicts the overall construction of a cutting apparatus 30 when looking from the side to the feeding direction of a plate-like member. FIG. 2 depicts the construction of the cutting apparatus 30 when looking from the front in the feeding direction of the plate-like member. FIG. 3 depicts a state where attachment holes 38 for attaching cutting blades 34 are formed on an upper die 44 or a lower die 32.

In the cutting apparatus 30, a plurality of the cutting blades 34 are fixed a predetermined spacing apart to the lower die (fixed die) 32 provided on a base 31. The lower die 32 in the present embodiment is fixed and does not move up and down.

The upper die (movable die) 44 is disposed facing the lower die 32 with the fed plate-like body 10 in between. The upper die 44 is capable of being moved in the up-down direction by a driving apparatus, not depicted, and moves toward and away from the lower die 32.

A plurality of cutting blades 34 of the same construction as the cutting blades 34 provided on the lower die 32 are fixed to the upper die 44 at a predetermined spacing.

The cutting blades 34 are cutting tools that extend in the same direction as the feeding direction of the plate-like body 10. The cutting blades 34 are constructed of blade portions 34a with sharp edges and fixing portions 34b for fixing the blade portions to the lower die 32 or the upper die 44. Note that although the blade portions 34a and the fixing portions 34b are separate members that are fixed to become integrated as cutting blades in the present embodiment, the blade portion 34a and the fixing portion 34b may be formed as an integrated member.

The blade portions 34a are formed so as to be elongated along the feeding direction of the plate-like body. To fix the blade portions 34a to the lower die 32 or the upper die 44, the fixing portions 34b are formed as rectangular solids that are elongated along the feeding direction of the plate-like body in keeping with the length direction of the blade portions 34a.

Note that a plurality (for example, two) of the fixing portions 34b according to the present embodiment are provided along the feeding direction of the plate-like body for each blade portion 34a. It is believed that by fixing one blade portion 34a not to one fixing portion 34b but to a plurality of the fixing portions 34b in this way, it is possible to fix the blade portions 34a more strongly. It is also possible to provide a plurality of insertion positions for one fixing portion 34b.

As the material of the fixing portions 34b, it is possible to use a hardening material that is hardened by carrying out a hardening process.

The lower die 32 includes a first member (hereinafter sometimes referred to as the “attachment hole forming portion”) 35, on which inner wall surfaces 37 of the attachment holes 38 for attaching the cutting blades 34 are formed, and a second member (hereinafter sometimes referred to as the “base portion”) 36 that is disposed below the first member 35 and whose upper surface constructs the inner bottom surfaces 42 of the attachment holes 38.

The attachment holes 38 are provided with a size that enables the fixing portions 34b of the cutting blades 34 to be inserted and fixed. In the present embodiment, since the fixing portions 34b are provided at two positions along the feeding direction of the plate-like body on a single cutting blade 34, in accordance with this the attachment holes 38 are also formed on the lower die 32 at two positions per cutting blade 34 along the feeding direction of the plate-like body.

As the attachment hole forming portion 35, it is favorable to use a hardening material that is hardened by carrying out a hardening process. That is, deformation of the attachment holes 38 is prevented by attaching the fixing portions 34b to the attachment holes 38 using a hardening material that has been hardened.

If the attachment hole forming portion 35 is constructed of a hardening material, since the material is hard, it is no longer possible to machine the holes by carrying out a milling process using a milling cutter. For this reason, the formation of the attachment holes 38 according to the present invention is carried out by wire cut discharge machining.

However, when wire cut discharge machining is carried out, it is not possible to form holes with the inner bottom surfaces remaining, and it is only possible to form through-holes. For this reason, in the present embodiment, the periphery (inner wall surfaces) of the attachment holes 38 are constructed of the attachment hole forming portion 35 made of a hardening material and the attachment holes 38 are constructed by disposing the base portion 36 below the attachment hole forming portion 35 so that the inner bottom surfaces 42 of the attachment holes 38 are constructed of a normal thermal-refined material or the like that is not especially hard.

In keeping with the form of the fixing portions 34b, the attachment holes 38 are formed so that the inner wall surfaces 37 contact the outer circumferential surfaces of the fixing portions 34b around the entire peripheries of the fixing portions 34b. More specifically, since the cross-sectional form of the fixing portions 34b is rectangular, the form of the attachment holes 38 is also rectangular.

The upper die 44 uses a similar construction to the lower die 32 described above. That is, the upper die 44 includes a first member (hereinafter sometimes referred to as the “attachment hole forming portion”) 45 on which inner wall surfaces 37 of the attachment holes 38 for attaching the cutting blades 34 are formed and a second member (hereinafter sometimes referred to as the “base portion”) 46 that is disposed above the first member 45 and whose lower surface constructs the inner bottom surfaces 42 of the attachment holes 38.

The attachment holes 38 are provided with a size that enables the fixing portions 34b of the cutting blades 34 to be inserted and fixed. As the attachment hole forming portion 45, it is favorable to use a hardening material that is hardened by carrying out a hardening process. That is, deformation of the attachment holes 38 is prevented by attaching the fixing portions 34b to the attachment holes 38 using a hardening material that has been hardened.

If the attachment hole forming portion 45 is constructed of a hardening material, since the material is hard, it is no longer possible to machine the holes by carrying out a milling process using a milling cutter. For this reason, the formation of the attachment holes 38 according to the present invention is carried out by wire cut discharge machining.

However, when wire cut discharge machining is carried out, it is not possible to form holes with the inner bottom surface remaining, and it is only possible to form through-holes. For this reason, in the present embodiment, the periphery (inner wall surfaces) of the attachment holes 38 are constructed of the attachment hole forming portion 45 made of a hardening material and the attachment holes 38 are constructed by disposing the base portion 46 below the attachment hole forming portion 45 so that the inner bottom surfaces (upper surfaces, top surfaces) of the attachment holes 38 are composed of a normal thermal-refined material or the like that is not especially hard.

For the cutting blades 34 attached to the upper die 44, since the fixing portions 34b are provided at two positions along the feeding direction of the plate-like body for a single cutting blade 34, in accordance with this the attachment holes 38 are also formed at two positions per cutting blade 34 on the upper die 44 along the feeding direction of the plate-like body.

A support portion 48 is disposed above the base portion 46 of the upper die 44. The support portion 48 is connected to a driving apparatus, not depicted, and the entire upper die 44 is driven so as to move up and down relative to the lower die 32.

A holding means 49 that prevents the cutting blades 34 from falling off the upper die 44 is provided on the upper die 44. Note that the holding means 49 in the present embodiment is composed of screws for screwing the cutting blades 34 from below into front end portions (lower end portions) of pressing pins 58, described later.

The upper die 44 is also provided with a moving means 56 for causing movement of individual cutting blades between a cutting position where such blades are capable of cutting the plate-like body and a non-cutting position where such blades cannot cut the plate-like body by moving the cutting blades 34 provided on the upper die 44 toward and away from the cutting blades 34 provided on the lower die 32.

The moving means 56 is constructed of the pressing pins 58 that press the cutting blades 34 from above. The pressing pins 58 are disposed so as to be capable of sliding in an up-down direction inside through-holes 59 that pass through the support portion 48 and the base portion 46. An upper portion of each pressing pin 58 is a large diameter portion 58a and a lower portion is a small diameter portion 58b, with the large diameter portions 58a being housed inside the through-holes 59 formed in the support portion 48.

The front end portion (lower end portion) of each through-hole 59 is formed so as to pass through inside an attachment hole 38 of the attachment hole forming portion 45 and when the pressing pins 58 are lowered, the lower end portions of the pressing pins 58 protrude from the through-holes 59. The lower end portions of the pressing pins 58 are screwed to the screws 49 that protrude downward from the cutting blades 34 (the fixing portions 34b) and are thereby fixed to the cutting blades 34, so that when the pressing pins 58 are lowered, the cutting blades 34 are pressed downward. The position to which the cutting blades 34 are pressed downward is the cutting position where the cutting blades 34 are capable of cutting the plate-like body.

Since the inner diameter of each through-hole 59 in which a pressing pin 58 is housed is smaller at the part formed in the base portion 46 than at the part formed in the support portion 48, the contact surface between the upper surface side of the base portion 46 of the through-hole 59 and a lower surface side of the support portion 48 of the through-hole 59 forms a step 61. A spring 62 is disposed between an upper surface of the step 61 and the large diameter portion 58a of the pressing pin 58. The spring 62 is energized in a direction where the pressing pin 58 is pressed upward.

One or more pressing plates 64 is/are disposed above the support portion 48. Each pressing plate 64 is capable of slidably moving on the upper surface of the support portion 48. When the pressing plate 64 has slidably moved so as to cover the opening at the top of a through-hole 59, the upper end portion of the pressing pin 58 is pressed so as to resist the energizing force of the spring 62. At this time, the lower end portion of the pressing pin 58 protrudes from the through-holes 59 and presses the cutting blade 34 downward. When the pressing plate 64 has slidably moved so as to uncover the opening at the top of a through-hole 59, the upper end portion of the pressing pin 58 protrudes upward due to the energizing force of the spring 62. At this time, the lower end portion of the pressing pin 58 becomes housed in the through-hole 59 and the cutting blade 34 moves upward due to the energizing force of the spring 50.

The position to which the cutting blade 34 rises is a non-cutting position where the cutting blade 34 is incapable of cutting the plate-like body.

Note that although the pressing plate 64 may be a flat plate, concave portions capable of housing the upper end portions of the pressing pins 58 may be formed at predetermined positions on the lower surface of the pressing plate 64. When the upper end portion of a pressing pin 58 is positioned in such a concave portion, the pressing pin 58 rises due to the energizing force of the spring 62 and the cutting blade 34 moves upward.

### Second Embodiment

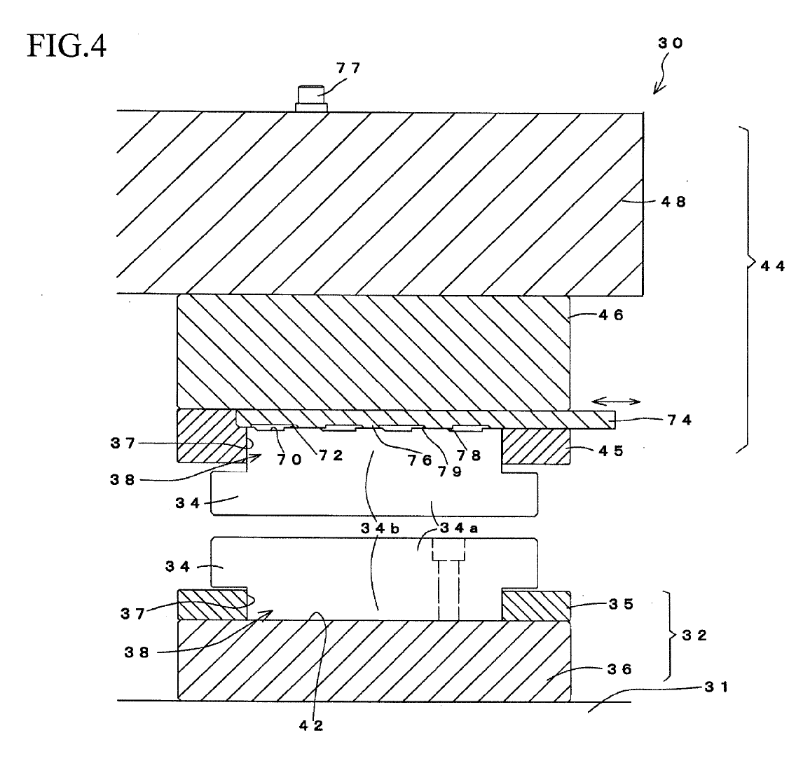

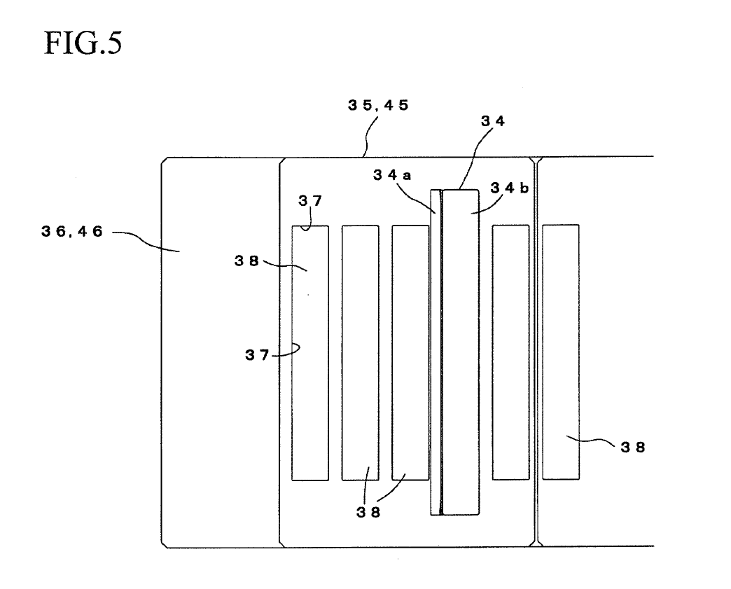

Next, a second embodiment of a cutting apparatus will be described with reference to FIGS. 4 and 5. Note that components that are the same as the embodiment described above have been assigned the same reference numerals and description thereof is omitted.

The second embodiment differs to the first embodiment in the construction of the moving means 56 for moving the cutting blades 34 attached to the upper die 44 between the cutting position where a cutting blade 34 is capable of cutting the plate-like body and the non-cutting position where the cutting blade 34 is incapable of cutting the plate-like body. In addition, in the present embodiment, one fixing portion 34b is provided per cutting blade 34 and one attachment hole 38 is formed per cutting blade 34. Each attachment hole 38 is formed so as to include the inner wall surface 37 that contacts the entire periphery of the fixing portion 34b and has an inner bottom surface 42.

In the present embodiment, pressing pins 58 like those described in the first embodiment are not provided. Accordingly, the fixing of the cutting blades 34 provided on the upper die 44 is carried out by fixing screws 77 disposed so as to pass from the support portion 48 through the base portion 46 and the attachment hole forming portion 45.

The front end portion (lower end portion) of each fixing screw 77 is a male screw portion that has a screw groove cut into the outer circumference of a shaft. On the upper end surface of each cutting blade 34, a female screw portion, where a screw thread is cut into the inner wall surface of a concave portion and which is capable of being screwed to the male screw at the lower end portion of a fixing screw 77, is formed.

By screwing the male screw portion at the lower end portion of each fixing screw 77 to the female screw portion at the upper end portion of each cutting blade 34, the cutting blades 34 are fixed to the upper die.

The upper end portion of each fixing screw 77 is disposed so as to protrude above the support portion 48, and by rotating such upper end portions, it is possible to loosen the fixing of the cutting blades 34.

The moving means 56 includes a plurality of concave portions 70 formed on the upper surface of the fixing portions 34b of each cutting blade 34 attached to the upper die 44, raising surfaces 72 formed on both sides of the concave portions 70, and one or more slide members 74 capable of slidably moving on a horizontal plane.

Each slide member 74 is disposed at a top portion (the boundary with the base portion 46) of the attachment hole forming portion 45 and is provided so as to move along the length direction of the fixing portions 34b.

A plurality of pressing protrusions 76 that contact the concave portions 70 and raising surfaces 72 formed on the upper surfaces of the cutting blades 34 are formed on the contact surface (lower surface) of each slide member 74 that contacts the upper surface of one or more fixing portions 34b.

For each concave portion 70 formed on each fixing portion 34b, at least one of the two wall surfaces in the feeding direction of the plate-like body (the length direction of the fixing portions, the sliding direction of the slide member) is formed as an inclined surface 78 so that the opening of the concave portion 70 widens in the upward direction (i.e., toward the contact surface of a slide member 74).

Also, at least one of two wall surfaces in the feeding direction of the plate-like body (the length direction of the fixing portions, the sliding direction of the slide member) of each pressing protrusion 76 of a slide member 74 is formed as an inclined surface 79 so that the pressing protrusion 76 narrows in the downward direction (i.e., toward the upper surface of the fixing portion 34b).

The wall surfaces formed as the inclined surfaces 78, 79 are formed so as to facilitate the pressing protrusions 76 riding up from inside the concave portions 70 onto the raising surfaces 72.

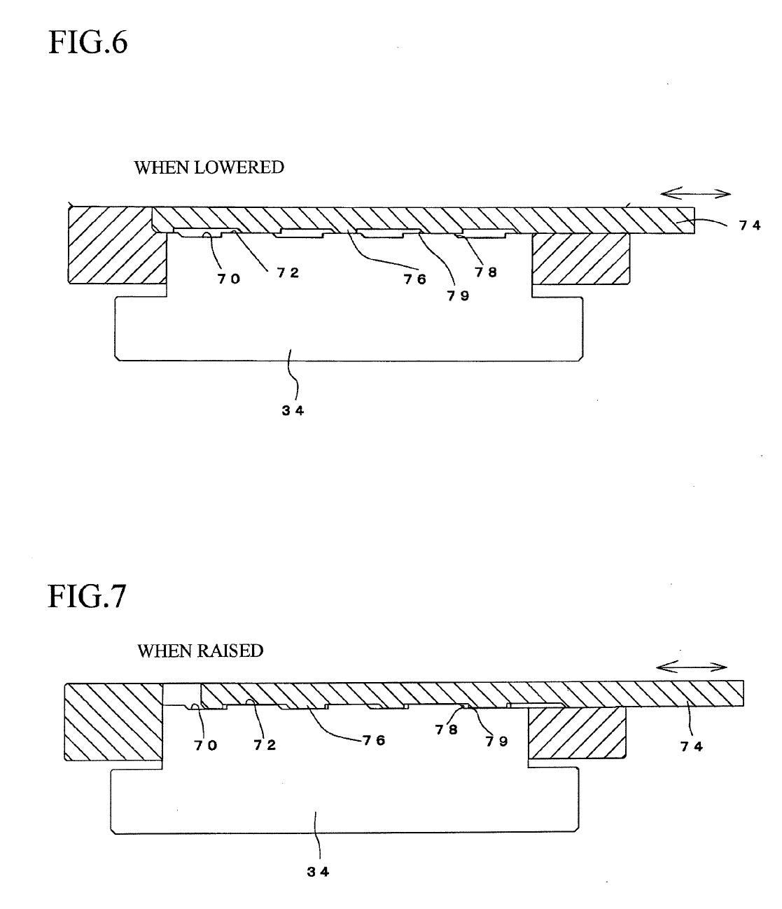

FIGS. 6 and 7 depict the operation of a slide member and a cutting blade.

Note that before a sliding operation of a slide member 74, the fixing screw 77 is loosened and it is necessary to open a gap between the upper end surface of the cutting blade 34 (i.e., the fixing portion 34b) and the slide member 74 to enable the slide member 74 to slide relative to the cutting blade 34. In this state, the lower end portion of the fixing screw 77 is fixed to the cutting blades 34 and the fixing screw 77 is loosened to an extent where the cutting blade 34 does not fall off.

In the present embodiment, since an energizing means is not provided for the cutting blades 34, after the fixing screw 77 has been loosened and the slide member 74 has been moved, the cutting blade 34 is manually lifted up and the cutting blade 34 is positioned at such position by tightening the fixing screw 77.

As depicted in FIG. 6, when the pressing protrusions 76 contact the raising surfaces 72, the cutting blade 34 on the upper die 44 is pressed downward by the pressing protrusions 76. The position to which the cutting blade 34 is pressed downward is the cutting position where the cutting blade 34 is capable of cutting the plate-like body.

As depicted in FIG. 7, when an operator has loosened the fixing screw 77, has moved a slide member 74 to the right in the drawing (in the feeding direction of the plate-like body), and has manually lifted the cutting blade 34, the pressing protrusions 76 are housed inside the concave portions 70 and the cutting blade 34 stops at a position that is raised above the cutting position. The operator tightens the fixing screw 77 at this position. This position where the cutting blade 34 has been raised is the non-cutting position where the cutting blade 34 is incapable of cutting the plate-like body.

When moving a cutting blade 34 from the non-cutting position to the cutting position, the operator loosens the fixing screw 77 and then moves the slide member 74 to the left in the drawing (in the opposite direction to the feeding direction of the plate-like body) from the state in FIG. 7 to the state in FIG. 6.

After this, after the operator manually raises the cutting blade 34, the pressing protrusions 76 that had advanced into the concave portions 70 stop at a position where the pressing protrusions 76 ride up onto the raising surfaces 72. After confirming the position of the cutting blade 34, the operator tightens the fixing screw 77 to fix the cutting blade 34 at the position confirmed as the cutting position.

Note that in the example described here, the inclined surfaces of the concave portions 70 and the inclined surfaces of the pressing protrusions 76 are both formed on the left in the drawing (the side where the pressing protrusions 76 that had advanced into the concave portions 70 move in a direction so as to ride up onto the raising surfaces 72).

In this way, by forming the inclined surfaces 78, 79 at at least the surfaces that come into contact when the slide member 74 has moved in the direction where the pressing protrusions 76 ride up onto the raising surfaces 72 out of both side surfaces of the concave portions 70 and both side surfaces of the pressing protrusions 76, it is possible to have the slide members 74 move smoothly relative to the fixing portions 34b.

Note that in the present embodiment as depicted in FIG. 5, an example is described where one fixing portion 34b is provided per blade portion 34a. However, in a case where a plurality of the fixing portions 34b are provided as in the first embodiment, the concave portions 70 and the raising surfaces 72 may be formed on the upper surfaces of the fixing portions 34b and the pressing protrusions 76 that press the fixing portions 34b may be formed on the slide member 74.

### Third Embodiment

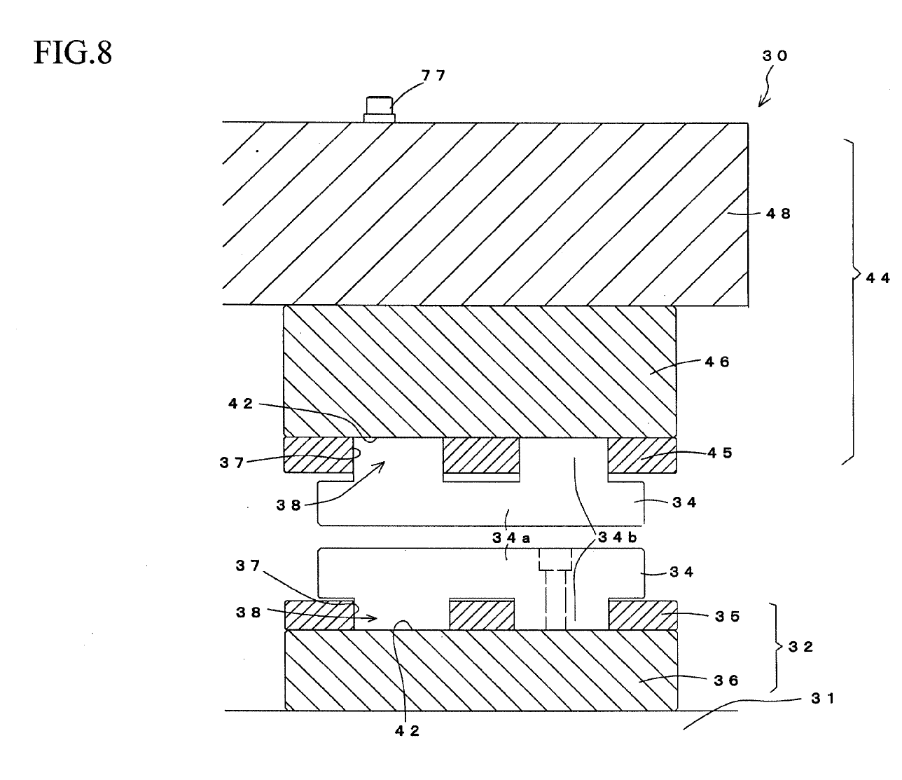

The present embodiment is an embodiment where a moving means for moving the cutting blades between the cutting position and the non-cutting position is not provided. Note that component elements that are the same as the embodiments described above have been assigned the same reference numerals and description thereof is omitted. FIG. 8 depicts the construction of the present embodiment.

With this construction, a plurality of the cutting blades 34 are fixed at a predetermined spacing onto the lower die 32 and a plurality of cutting blades 34 of the same construction as the cutting blades 34 provided on the lower die 32 are also fixed at a predetermined spacing to the upper die 44.

The cutting blades 34 fixed to the upper die 44 are fixed by the fixing screws 77 that extend from the upper end portion of the support portion 48 to the fixing portions 34b. Accordingly, the cutting blades 34 of the upper die 44 do not move toward and away from the cutting blades 34 of the lower die 32. This means that with the cutting apparatus 30 of this construction, when changing the fin width, it is possible to easily change the fin width by rotating the fixing screw 77 and removing predetermined cutting blades 34 from the upper die.

### Fourth Embodiment

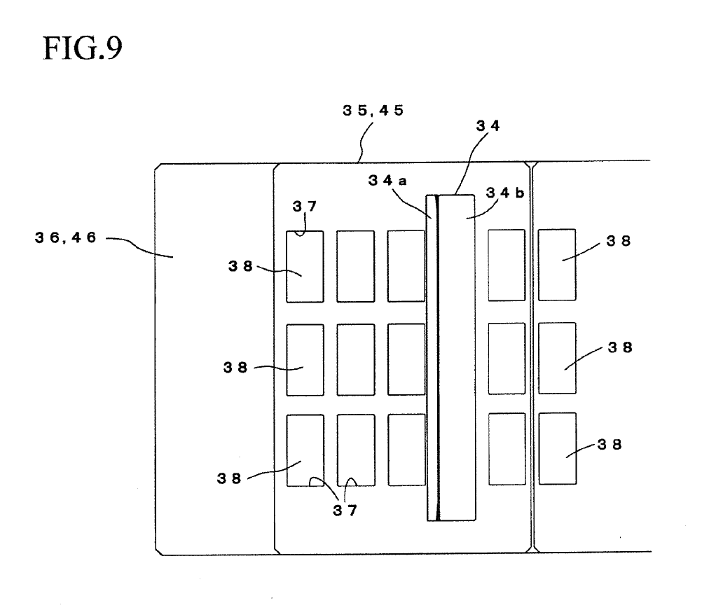

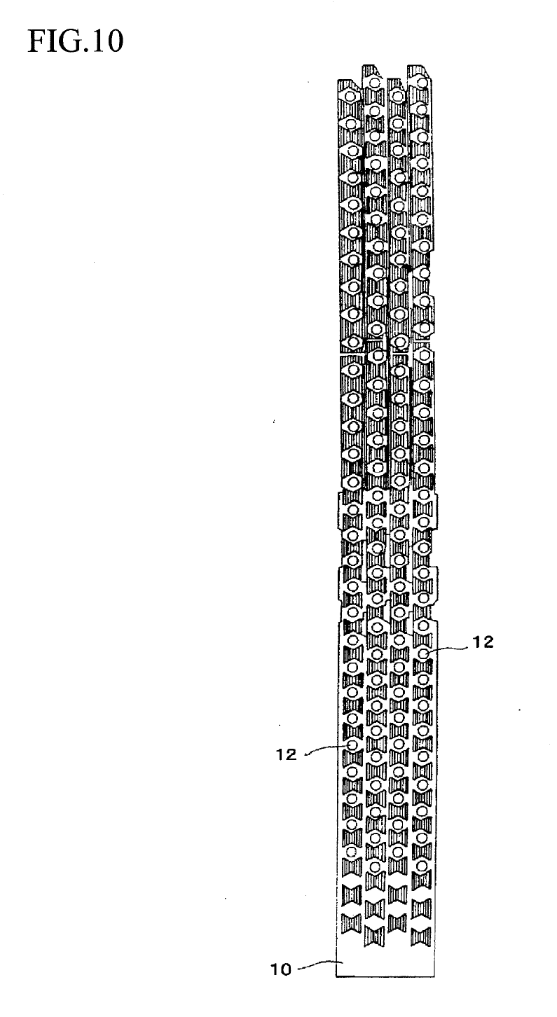

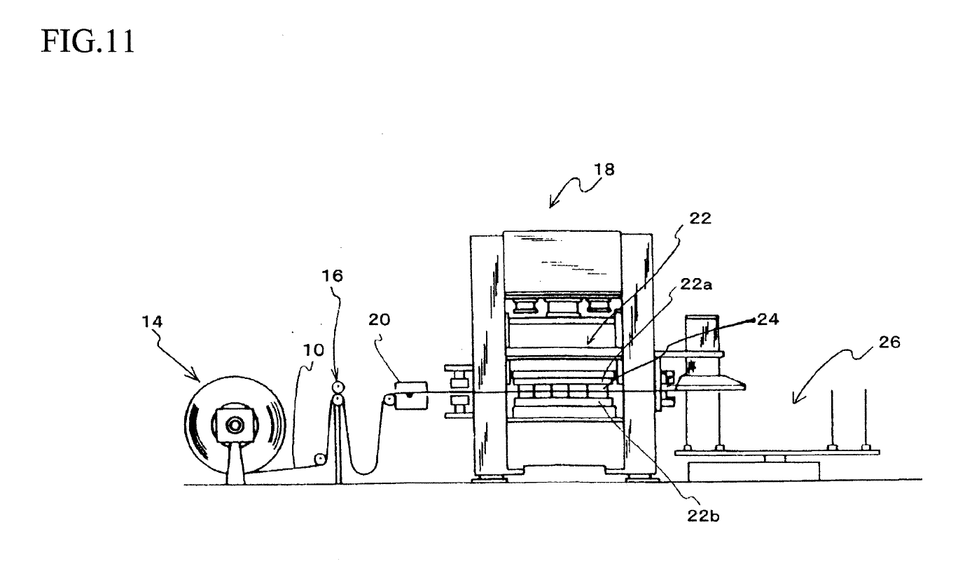

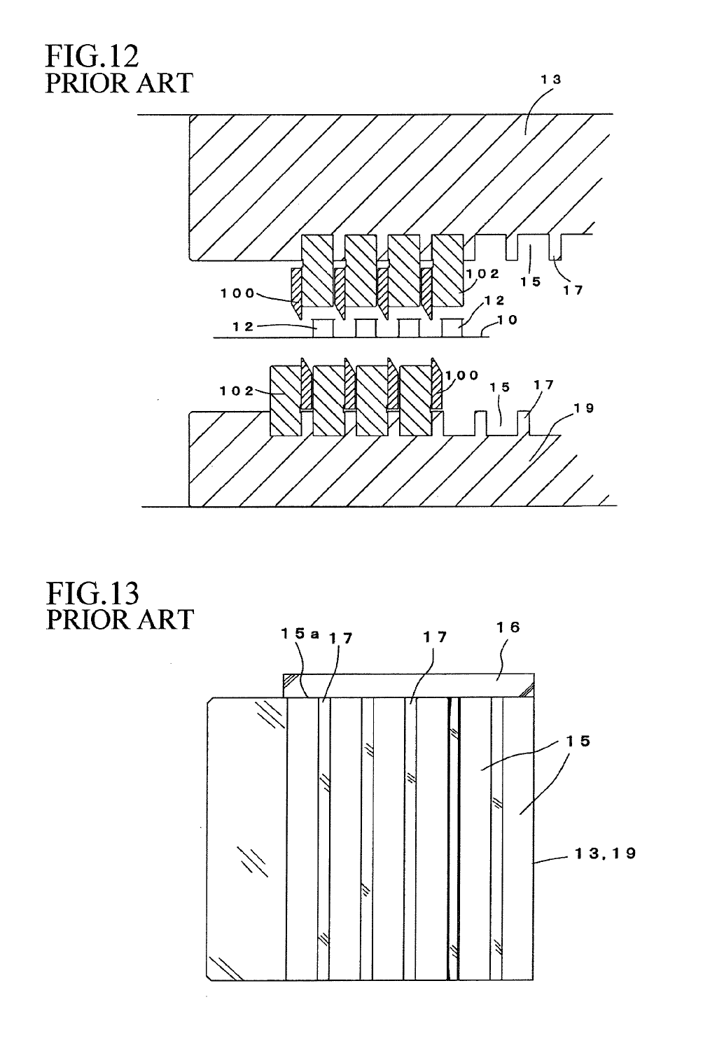

The various embodiments described above have one or two fixing portions 34b provided per blade portion 34a. However, as depicted in FIG. 9, the cutting apparatus according to the present invention may have three fixing portions 34b provided per blade portion 34a.

Note that the present embodiment may be constructed so that instead of three fixing portions 34b, insertion positions for the attachment holes 38 are formed at three positions on one fixing portion 34b.

Note that although a cutting apparatus for a metal strip 10 in which a plurality of collar-equipped holes are formed has been described in the above explanation, the present invention may also be applied to cutting a flat metal strip or a resin strip.

What is claimed is:

1. A cutting apparatus that cuts a plate-like body progressively and intermittently fed in a predetermined direction in a feeding direction thereof to form a plurality of narrow strips, comprising:
a first die that is disposed one of above and below a surface of the plate-like body and has a plurality of cutting blades, which include fixing portions, mounted thereon by attaching the fixing portions;
a second die that is disposed another of above and below the surface of the plate-like body and has a plurality of cutting blades, which correspond to the cutting blades mounted on the first die, cut the plate-like body, and include fixing portions, mounted thereon by attaching the fixing portions; and
a driving apparatus that drives at least one of the first die and the second die toward and away from another of the first die and the second die,
wherein a plurality of attachment holes into which the fixing portions are inserted and mounted are formed in the first die and the second die, and
each attachment hole is formed with inner wall surfaces that contact the entire periphery of a fixing portion and an inner bottom surface that contacts a bottom surface of the fixing portion.

2. A cutting apparatus according to claim 1,
wherein the first die and the second die include:
a first member that has through-holes, in which the inner wall surfaces of the attachment holes are formed, formed in a hardening material that has been hardened by hardening; and
a second member that is mounted on an opposite side of the first member to a side into which the fixing members are inserted and covers the through-holes of the first member to construct inner bottom surfaces of the attachment holes.

3. A cutting apparatus according to claim 1 or claim 2,
wherein at least one of the first die and the second die includes a moving means that causes the attached single or plurality of cutting blades to advance toward and withdraw from the plurality of cutting blades attached to the other mold to move the single or plurality of cutting blades between a cutting position where the cutting blades are capable of cutting the plate-like body and a non-cutting position where the cutting blades are incapable of cutting the plate-like body.

4. A cutting apparatus according to claim 3,
wherein the moving means
has one or a plurality of concave portions and raising surfaces formed on both sides of the concave portions formed on bottom surfaces of the fixing portions of the cutting blades,
is equipped with a slide member capable of sliding in contact with bottom surfaces of the fixing portions,
has one or a plurality of pressing protrusions that protrude toward the bottom surfaces of the fixing portions formed in a surface of the slide member that contacts the bottom surfaces of the fixing portions, and
is provided to cause the slide member to slide and, when the pressing protrusions have advanced into the concave portions of the bottom surfaces of the fixing portions, moves the cutting blades to the non-cutting position where the cutting blades are incapable of cutting the plate-like body, and when the pressing protrusions have ridden up onto the raising surfaces, moves the cutting blades to the cutting position where the cutting blades are capable of cutting the plate-like body.

5. A cutting apparatus according to claim 3,
wherein the moving means is equipped with pressing pins that contact bottom surfaces of the fixing portions of the cutting blades and press the bottom surfaces of the fixing portions so as to move the cutting blades between the non-cutting position where the cutting blades are incapable of cutting the plate-like body and the cutting position where the cutting blades are capable of cutting the plate-like body.

6. A cutting apparatus according to claim 1,
wherein the respective fixing portions have insertion positions for the attachment holes provided at a plurality of positions, and
a plurality of attachment holes are provided for each fixing portion to enable the plurality of insertion positions of the fixing portion to be inserted.

7. A cutting apparatus according to claim 2,
wherein the respective fixing portions have insertion positions for the attachment holes provided at a plurality of positions, and
a plurality of attachment holes are provided for each fixing portion to enable the plurality of insertion positions of the fixing portion to be inserted.

8. A cutting apparatus according to claim 3,
wherein the respective fixing portions have insertion positions for the attachment holes provided at a plurality of positions, and
a plurality of attachment holes are provided for each fixing portion to enable the plurality of insertion positions of the fixing portion to be inserted.

9. A cutting apparatus according to claim 4,
wherein the respective fixing portions have insertion positions for the attachment holes provided at a plurality of positions, and
a plurality of attachment holes are provided for each fixing portion to enable the plurality of insertion positions of the fixing portion to be inserted.

10. A cutting apparatus according to claim 5,
wherein the respective fixing portions have insertion positions for the attachment holes provided at a plurality of positions, and
a plurality of attachment holes are provided for each fixing portion to enable the plurality of insertion positions of the fixing portion to be inserted.
